(19) United States
(12) Patent Application Publication
(10) Pub. No.: US 2006/0120752 A1
(43) Pub. Date: Jun. 8, 2006

(54) System and method for generating an image of a label

(76) Inventors: Henry J. McVicker, Naples, FL (US); Joseph Samuel McVicker, Wayland, MA (US)

Correspondence Address: JONES DAY, 77 WEST WACKER, CHICAGO, IL, 60601-1692, US

(21) Appl. No.: 11/340,133

(22) Filed: Jan. 26, 2006

Related U.S. Application Data
(63) Continuation-in-part of application No. 11/004,071, filed on Dec. 3, 2004.

(51) Int. Cl. G03G 15/00

(52) U.S. Cl. 399/107; 399/361

(57) ABSTRACT

A system and method are disclosed for generating an image of a wine bottle label. The system includes a database of wine bottle label images, an integration engine for selecting at least one wine label image from the database, and a means for outputting the image. The output can be either in a printed format or electronic. The image can be outputted in a format that includes other information relevant to the recipient, such as place of purchase, or commemorative information. The system also provides a means for to integrate the acquisition and outputting of label images with existing inventory management and point of sale systems.

This is a continuation-in-part of U.S. patent application Ser. No. 11/004,071, entitled “Apparatus and Method for Obtaining an Image of an Arcuate Surface,” filed Dec. 3, 2004.

### BACKGROUND OF THE INVENTION

1. Field of the Invention

The invention relates in general to a system and method for generating images of bottle labels, and in particular images of labels of wine bottles from an electronic database of such bottle label images. The present invention further relates to a system for storing and retrieving images of wine bottle labels, for use by collectors, restaurants, wine purveyors, and others interested in wines.

2. Description of the Prior Art

The wine industry and its enthusiasts have shown a continuing interest in collecting information from wine bottle labels. Such information is typically used for one or more purposes including recordation of the date, style, and producer as they relate to the quality and value of the wine. Another purpose is for collectors to keep a record of the artistic content of the label along with notes on the consumptive experience.

Numerous methods to remove labels from the wine bottles have been tried including soaking, steaming, adhesive carrier removal, scraping with a razor, and various combinations of the foregoing. The most popular method employs the use of a clear adhesive tape that is placed over the label and then removed, thereby pulling the label off of the bottle. As can be readily understood, this method often leaves part of the label on the bottle, depending on the tenacity of the label's original adhesive. In some varieties of wines, a traditional paper label is substituted with a painted label that is a permanent part of the bottle.

Two less popular methods for collecting label information utilize either photography or placing the bottle on a flatbed scanning device. These methods usually produce poor results because both flatbed scanners and cameras are unable to focus consistently due to the curved surface of the bottle; specifically with respect to photography, there are many variables that would have to be adjusted, and such adjustments would require a person highly skilled in photography to make acceptable images. These techniques therefore are not commonly used.

Beyond appreciation of the artistic aspects of wine bottle labels, wine purveyors and serious wine collectors have a need to use the information on wine bottle labels for inventory management purposes. Such information may include the type of wine, its date, its country of origin, its distributor, and other such information. Barcode labels that encode such information have become increasingly common on wine bottles. Typically, the barcode label is a supplemental label separate from the manufacturer's primary label. The bar-coded label can be scanned using standard scanning systems for sales and inventory purposes. In some instances, private collectors also use a bar coded system to keep track of their wine cellar inventory. In both commercial and private applications, the scanned information is typically stored and analyzed using a variety of commonly available software programs. One such system is sold under the name “Wine Collector 150” by Intelliscanner, Inc., at www.intelliscanner.com. Another system sold under the name “eSommelier”, and available at www.esommelier.net provides a touch-screen wine collection management system. Neither of these systems includes an image of the actual wine bottle label as part of the data management system. The Alcohol and Tobacco Tax and Trade Bureau of the United States Department of the Treasury maintains an on-line searchable database of Certificate of Label Approvals (COLAs) issued since 1996. The database includes images of some label elements, but does not include particular wine information such as the year of production of a particular bottle. These images are available at http://www.atf.treas.gov/alcohol/colas.htm, where they are searchable by certain keywords

It would be desirable to provide an electronic database of wine bottle label images that includes all relevant information from a bottle of wine.

It would be further desirable to generate images of wine bottle labels from an electronic database of such images, such a database either being generated through a scanning device or otherwise, such that wine bottle label images can be included in a desired formatted printout.

It would be further desirable to provide a system for storing and retrieving wine bottle label images, such as for use by wine collectors, distributors, or purveyors.

It would further be desirable to provide a system for storing and retrieving wine bottle label images, either as part of or integrated with a wine-related data management system, the data management system further including information about the wine, and other information such as its cost, date of purchase, date of sale or use, and other information relevant to inventory control.

### SUMMARY OF THE INVENTION

One aspect of the present invention relates to a system and method for producing an image of a bottle label. The system comprises (a) a database of label images, each image in the database having a corresponding code, (b) a processor for receiving a label code and generating an image of the label corresponding to that code, and (c) a means for inputting a label code into the processor, such that upon receiving the inputted code the processor can access the database and generate an image of the corresponding label. The processor can store the database of images, or the processor can access the database via the Internet. The label images in the database can be entered by a scanner that scans the wine labels while they are still on the bottle of wine, or the database can comprise pre-existing electronic images of wine bottle labels that are uploaded or downloaded from another source into the database, or the database can comprise images from both a scanner and pre-existing electronic images. In one embodiment, the system finds particular utility in point-of-sale environments such as restaurants and wine purveying establishments, at which an image of a label can be generated for a customer at the time the customer purchases the wine. The output of the system can be in the form of a paper printout, or it can be an electronic image that can be downloaded to a customer's electronic device such as a personal digital assistant, cell-phone, or e-mail account. In either case, the output can include information in addition to that on the wine bottle label. For example, the output can include any one or more of the date of sale, the price of the wine, the place of purchase, or information commemorating a special event at which the wine was enjoyed.

In another aspect, the present invention further relates to a system for storing and retrieving images of wine bottle labels, for use by collectors, restaurants, wine purveyors, and others interested in wines, such as for use in connection with a catalog, an inventory control system, or a system for tracking customer purchases. Such a system comprises (a) a database of wine bottle label images, (b) a processor for selecting at least one desired wine bottle label image from the database, and (c) a means for outputting the image in a predetermined format. The system can be a subscriber-based system, with digital label images being inputted by or on behalf of subscribers, such as wine producers or distributors. Images also can be inputted to the database by consumers, collectors, or groups of consumers or collectors, who can access the database through a website. Records of images accessed for output can be tracked so that wine producers or distributors can know which wines have been purchased by which customers, to facilitate customer loyalty programs. The wine producers and distributors also can use the wine label images to create electronic catalogs that can be tailored to the interests of particular purchasers.

The system of the present invention can include a method and apparatus for imaging a wine label on an arcuate surface of a wine bottle, the apparatus comprising a first device for providing a focused image of the arcuate surface that is compensated for depth of field differences; and a second device for receiving and recording the focused image of the arcuate surface. In one embodiment, such an apparatus uses a scanner to capture a sharp, photographic quality image of the manufacturer's label on a wine bottle. The scanning apparatus is associated with a cylindrical imaging chamber having an open top and a substantially closed bottom. In one embodiment, the imaging chamber may comprise two partial cylinders in order to allow adjustability for different diameter bottles. A wine bottle is placed into the imaging chamber through the opening in the top thereof. Preferably, the space between the bottle and the open top of the imaging chamber is sealed with a flexible skirt to exclude any ambient light. The scanner associated with the imaging chamber travels in at least an arcuate path with respect to the bottle along a given radius from the center of the chamber to scan the image. Alternatively, a rotating base such as a rotatable turntable or series of rollers may be placed in the bottom of the imaging chamber to receive the wine bottle and, upon command from a controller, rotates at a given speed past a fixed scanner associated with the chamber to image the label. Where the rotating base is used, a centering means may be provided to insure the bottle rotates on a centered axis.

In yet another embodiment, the imaging chamber is configured as a curved cradle comprising a series of rollers and a fixed scanning element. A bottle is placed horizontally on the rollers. One or more of the rollers is powered by a motor and drive system used to rotate the bottle whereby the label passes across the fixed scanning element. This approach is similar to printer/scanners where paper is pulled by a powered roller across a scanning element to accomplish the scanning process. In this embodiment the bottle is held against the rollers by the gravity of its own weight. Alternatively, the cradle could be oriented vertically with the inclusion of counter pressure rollers located opposite to the main rollers. The vertical system could include base rollers or turntable elements to eliminate rotational friction forces at the base of the bottle, or to power the rotation motion. Both embodiments are particularly well suited to accommodating different diameter bottles because the label maintains a constant distance from the scanning element.

In still another embodiment, the scanning apparatus may comprise a hand-held scanner. The hand-held scanner would provide flexibility to scan a bottle label at a remote location. Preferably, such a hand-held scanner apparatus would use a roller system to measure and compensate for the different manual scan speeds of the individual users. Such roller systems are well known to those skilled in the art.

In a further embodiment, a charge coupled device (hereinafter “CCD”) or device with a lens that compensates for the curvature of the label may be used. With the CCD embodiment, the compensating lens presents an image of the label in a flat plane and that image is transferred through a focusing lens to the CCD device from which the stored image may be transferred to any remote storage device. A frame holds the entire assemblage in the proper relationship such that the user simply places the frame against the curved surface and the image can be captured.

In another embodiment, it is possible to use only a focusing lens and the CCD chip to image the object. This system eliminates the compensating lens. This system compensates for the curvature by optimizing depth of field settings; thus, to obtain a clear image, proper lighting, proper focusing distance, and the quality of the lens all become increasingly important. The system can be properly adjusted and placed in a frame to hold the elements in the proper relationship to each other. Such a system would also be preset and non-adjustable to function properly and require no expertise in using it. The frame need only be placed against the curved surface from which the image is to be taken.

The image obtained may be transferred to a variety of output or storage devices. Such output and storage devices could be anything from basic printing to other electronic media that may include digital disk storage, memory chips, CD's, DVD's, and other commonly used computer peripherals. Similarly, the information may be transferred to other devices such as wireless networks, computers, and hand-held PDA's. Future storage technology media are intended to be encompassed and utilized by the present invention.

A preferred embodiment of the novel invention allows a simple and convenient scanning of wine labels to generate data that is outputted to various means that can be supplied to wine consumers in real time in a dynamic restaurant environment. In addition, the restaurant merchant may wish to provide the customer with other information as part of the reproduced label such as restaurant information, food eaten, the date on which the event took place, company present, retail locations selling the subject wine, and the like.

A controller, such as a microprocessor, may be associated with the scanning apparatus to activate the scanning function, input additional textual information, and then transfer the electronic image to an output device such as a printer, or a remote device such as a digital disk storage unit, memory chips, CD's, DVD's, PDA's and the like.

A key feature of the invention is the inclusion of wine label images in the database of wine information Such a database could be generated privately using the device and method described above, such as by wine collectors, wine purveyors, and restaurants, to reflect their own private stocks of wine. Alternatively, such databases could be developed and maintained by public agencies or by private interest groups, such as wine producers or distributors. One desiring to generate a printed image of a wine bottle label could access the database and enter an appropriate code corresponding to the particular wine bottle image. The wine bottle label image would then be printed out, either alone, or in a desired format with other pertinent information, such as for a receipt, a memento of a dining experience, or for an album of images for a collector.

It is an object of the invention to provide access to an electronic database of wine label images, whether generated using an apparatus for scanning images on arcuate surfaces or other means, to enable one to generate a printed image of a wine bottle label.

It is another object of the invention to provide a system and method for obtaining a printed image of a wine bottle label from an electronic database of wine bottle label images, such printed images being in a format that optionally includes other information.

It is still another object of the invention to provide a system and method of producing a printed or electronic record of a wine-related experience, such as a receipt, restaurant memento, retail locations selling the wine, or album page, which record contains the image of one or more wine bottle labels and other pertinent information.

The invention further relates to a system and method for providing an image of a wine bottle label as part of a record with other pertinent information, the image of the wine bottle label being accessed from an electronic database of wine label images. The record including the image can be printed or electronic.

### BRIEF DESCRIPTION OF THE DRAWINGS

These and other more detailed objects of the present invention will be disclosed when taken in conjunction with the following Detailed Description of the Drawings in which like numerals represent like elements and in which:

FIG. 1 A, is a side cross-sectional view of a first embodiment of an apparatus of the present inventions having a bottle placed within an adjustable imaging chamber in which a scanner moves in an arcuate path.

FIG. 1 B is a top plan view of the chamber portion of the embodiment of FIG. 1 A, illustrating the arcuate movement of the scanning device with respect to a bottle.

FIG. 2 A is a side cross-sectional view of the chamber of a second embodiment of an apparatus of the present invention having an adjustable imaging chamber in which a bottle is rotated past a fixed scanning element;

FIG. 2 B is a top plan view of the chamber portion of FIG. 2 B, showing the rotation of the bottle with respect to a fixed scanning element.

FIGS. 3A, B, C are top plan, side elevation, and front elevation views, respectively, of a third embodiment of an apparatus of the present invention, wherein the imaging chamber is configured as a cradle in the horizontal orientation and having a roller system whereby the bottle label is rotated past a fixed scanning element;

FIG. 4 is a side view of a fourth embodiment of an apparatus of the present invention in which the scanning element is hand-held;

FIG. 5 A, is a side view in partial cross-section of a fifth embodiment of an apparatus of the present invention in which a frame holds a compensating lens, a focusing lens, and a CCD chip in proper relationship with each other to form a simple apparatus for imaging an arcuate surface such as a wine bottle.

FIG. 5 B is a top plan view of the embodiment of FIG. 5 A in which the frame is omitted for the sake of clarity.

FIG. 6 illustrates an embodiment similar to that of FIG. 1A but wherein all components of the apparatus are disposed within a housing to provide an all-in-one system.

FIG. 7 is a schematic drawing of the relationships among the various components of the systems of the present invention.

### DETAILED DESCRIPTION OF THE DRAWINGS

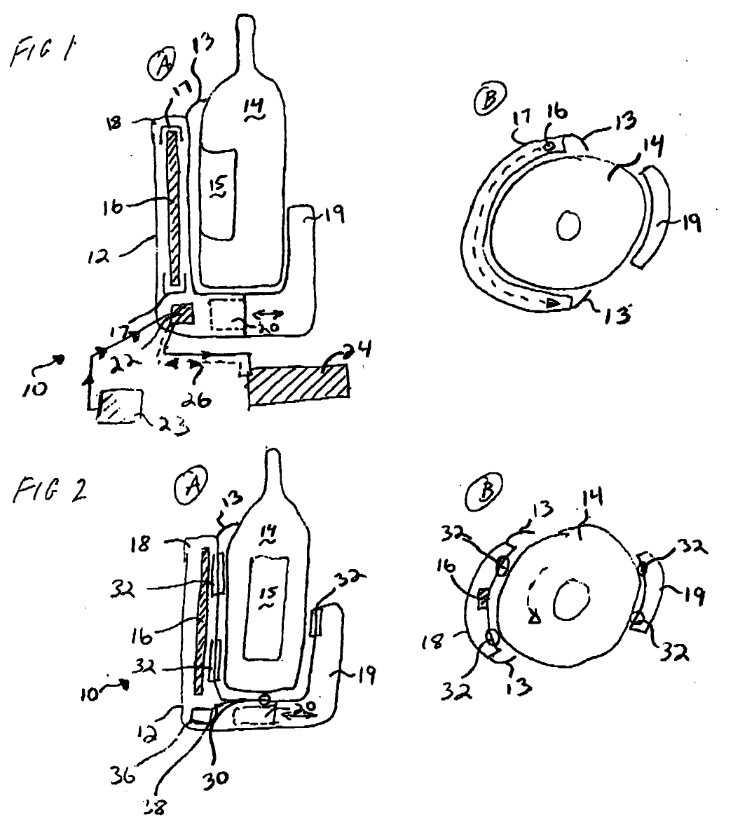

FIG. 1 is a schematic representation of a first embodiment of an apparatus for obtaining an image of a wine bottle label. The apparatus 10 comprises an imaging chamber 12. Chamber 12 can be in the form of a unitary, substantially cylindrical body. Alternatively, chamber 12 can comprise two or more partial cylinder walls 18, 19 that can be adjusted away from or toward each other to accommodate different diameter bottles. In the illustrated embodiment, partial cylinder wall 19 has at its base a protuberance 20 that extends into a corresponding slot in the base of particularly cylinder wall 18. A wine bottle 14 with label 15 is placed within the imaging chamber 12. Any well-known type of imaging device 16, such as a scanner, may be associated with a wall of the imaging chamber 12 as shown. In the illustrated embodiment, the scanner or imaging device 16 moves along arcuate guide means 17 in at least an arcuate path about the bottle 14 to scan the label 15. This arcuate movement is analogous to the movement of a scanning device in one plane as in conventional flatbed scanners, but with the scanner guide means 17 defining an arcuate path rather than a linear path. Thus, the novel arcuate path scanner can utilize a conventional scanning mechanism, such as a motor 12, linkage (not shown for clarity), and guide means 17, but with the guide means 17 defining an arcuate or circular path instead of a linear path as in a flatbed scanner. One skilled in the art would know how to make and use such a device. In the present invention, the arcuate path is defined by guides 17 at the top and/or bottom of the imaging chamber 12.

In a preferred embodiment, one or more flexible skirts or aprons 13 cover the space at the top of the imaging device 16 between the bottle 14 and the inner wall of the imaging chamber 12 to exclude ambient light from entering the imaging chamber 12. Additional light blocking flexible skirts 13 can be disposed at the vertical edges of partial cylinder wall 18.

A controller 22, preferably in the form of a microcomputer, can be programmed to control the movement of the imaging device 16 along the arcuate path formed by the guides 17. It also can be programmed to enable the scanned image to be transmitted along path 26 either to a device 24 such as a printer for printing; alternatively, device 24 can be a storage device, such as a digital disk storage unit, memory chips, CD's, DVD's, PDA's, and the like. As is known in the art, such transmission can be accomplished either wirelessly or along a circuit. As stated above, the controller 22 can cause the scanner 16 to move in a circle about the bottle 14 or in an arcuate path just covering the label 15 to be scanned. Associated with controller 22 is an optional input device such as a keyboard or other data entry device shown schematically as block 23. With the data entry device, any desired textual information could be added to an output format of the scanned label, such as date, restaurant, food ordered, and persons present. In addition, information regarding the label 15 could be entered. Such information could include a copyright notice caveat, a statement of use such as “For label collector's use only”, and the like. Of course the microprocessor or controller 22 could be programmed to add any desired appropriate message to an output format that includes the scanned image of label 15.

The controller 22 can be disposed within a wall of the imaging chamber 12, as shown in FIG. 1A. Alternatively, controller 22 could be located apart from the imaging chamber 12, and coupled thereto with appropriate cables or wireless transmitting devices. The controller 22 also may be programmed to automatically adjust the scanned image for correct reproduction.

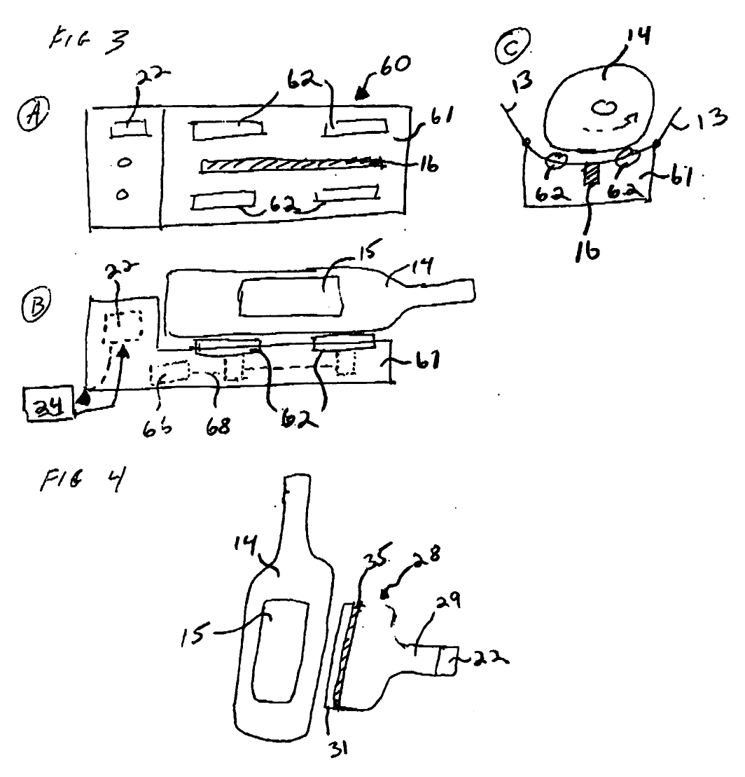

FIGS. 2A, 2B illustrate a second embodiment of a wine label scanning apparatus. In this embodiment, instead of moving the imaging device 16 along the arcuate path defined by guides 18, a rotating base 30 may be placed in the bottom of the imaging chamber 12 and rotated in a given direction by motor 36 coupled to rotating base 30 by drive system 38, all under the control of microprocessor 22, omitted for charity. In such case, the imaging device 16 is fixed and the bottle with the label is rotated past the fixed imaging device 16 and imaged. The rotating base 30 can be, for example, either a turntable or a plurality of rollers. In this embodiment, it is important that the bottle be properly centered on rotating base 30. This can be accomplished by proper adjustment of partial chamber wall 19 with respect to partial chamber wall 18. Additionally, rollers 32 disposed on the inner surfaces of chamber walls 18, 19 can serve as means for centering a bottle 14 within chamber 12. Again, such operation would be easily understood by one skilled in the art.

As in the first embodiment, the output device, which may be a printer or other means including electronic or computer media, may be contained within the main apparatus or could be separately connected via wires or wireless means.

FIG. 2B is a top view of the imaging chamber 12 with a bottle 14, shown in cross-section, placed therein. The imaging device or scanning element 16 is shown within the walls of the imaging chamber 12. An arrow indicates the direction of rotation of bottle 14. The optional flexible skirts or aprons 13 are shown covering the spaces between the inner wall of the imaging chamber 12 and the bottle 14 to prevent ambient light from entering therein. The microprocessor 22 and optional input device 23 and output device 24 as shown in FIG. 1 would also be used in FIG. 2 but are omitted for clarity. It will be understood by those skilled in the art that if a fixed scanner or imaging device 16 is used in FIGS. 2A, B, then the rotating base 30 would rotate bottle 14 in the same or the opposite direction under the direction of the controller or microprocessor 22 so that label 15 will pass the fixed scanner 16.

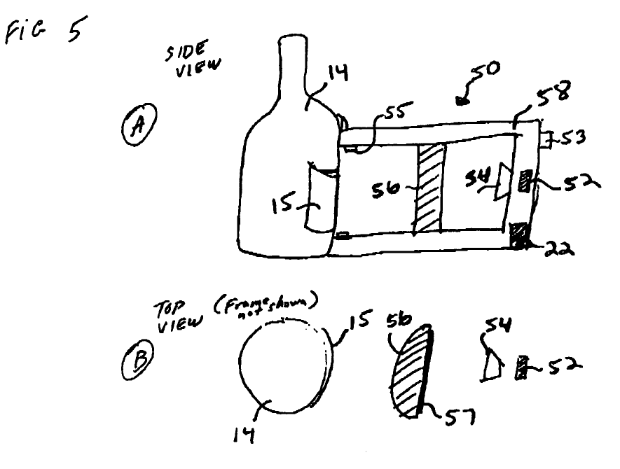

FIGS. 3A, 3B, and 3C illustrates a top plan view, a side elevation view, and a front elevation view, respectively, of yet another embodiment 60 of a wine label scanning apparatus. In this embodiment, chamber 12 is configured as a curved cradle 61 disposed in a substantially horizontal orientation. The inner surface of the cradle 61 is provided with a plurality of rollers 62 and a fixed scanning element 16. A bottle 14 is placed horizontally on the rollers. One or more of the rollers 62 is powered by motor 66 and drive system 68, indicated by phantom lines in FIG. 3B. Rotation of the roller 62 causes bottle 14 to rotate such that label 15 passes across fixed scanning element 16. The weight of bottle 14 holds it in proper position against rollers 62. Thus, this embodiment can more easily accommodate bottles of different diameters Light-blocking flexible skirts 13 can be disposed along the edges of cradle 61 to exclude ambient light while the image of label 15 is being scanned. System 60 can be controlled by controller 22, which can be disposed within a housing of cradle 61, as shown in FIGS. 3A, 3B, or can be separate. Output device 24 can be a printer or storage device as described above.

FIG. 4 illustrates yet another embodiment, in which a hand-held scanner is used to scan the bottle label. The hand-held scanner 28 can have a handle 29 in which a controller 22, such as a microprocessor, is located. On the scanning portion 35, a flexible shield 31 preferably is provided to exclude light from the region being scanned while the scanner 28 is being moved over the label 15 on bottle 14. Again, the controller 22 has storage means for storing the scanned data. Such data can be sent to a printer or wirelessly transmitted to a remotely located device as explained above with respect to the controller of FIG. 1.

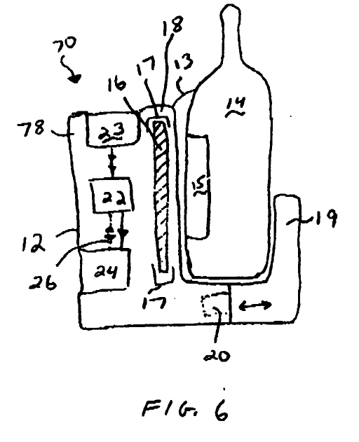

FIG. 5A is a schematic representation of an imaging system 50 that has no moving parts. The system 50 includes a CCD chip 52, a focusing lens 54 and, optionally, a compensating lens 56 all held in proper relationship with each other with a frame 58. The frame facilitates use of the device in a simple manner by one without expertise with regard to the type of lenses to be used, the proper distance between the focusing lens and the CCD chip 52 and, if used, the proper distance of the compensating lens 56 from the label 15 or other arcuate surface.

The compensating lens 56 can be used to correct for the different depths of field on the label 15 or other arcuate surface that is to be imaged. It provides a focused image 57 on its reverse side as shown in FIG. 5B.

As shown in FIG. 5A, lights 55 can be provided on the frame 58 to provide proper illumination of the image to be captured. Also, for those who are unskilled in the art, micro-switches 53 can be provided on the outer end of the frame 58 to actuate when the frame 58 is properly positioned with respect to the arcuate surface to be imaged. These can be used to provide power to an indicator of any desired type such as, for example only, the lights 55 to indicate to the user that the frame is properly positioned against the arcuate surface. The system can be controlled by controller 22 mounted to frame 58.

As stated previously, FIG. 5B is a side view of the system shown in FIG. 5A with the frame 58 being omitted for purposes of clarity of the drawings. It will be seen that the compensating lens 56, if used, causes an image of the arcuate surface, or label 15, to be present on its rear surface as a plane view 57 thus resolving the different depth of fields that occur with relation to the label or arcuate surface.

As stated earlier, if desired, the compensating lens 56 can be eliminated with the use of frame 58 to hold the proper focusing lens 54 at a proper fixed distance between the arcuate surface 15 and the focusing lens 54 to be imaged to correct for different depths of field on the arcuate surface or label 15 and the proper fixed distance between the focusing lens 54 and the CCD chip 52. Such fixed system will allow a novice to use the device, or system 50, with a minimum of instruction.

Further, in any of the embodiments disclosed herein, an output device 24, whether it be a printer or another device disclosed herein, can be either a separate element or an integral unit, such as integral with the housing for image chamber 12, or for hand-held scanner 28, or frame 58. Thus an apparatus in accordance with the present invention can comprise separate components, or can be an all-in-one system, as may be desired for any particular application. For example, FIG. 6 illustrates an embodiment of the invention very similar to that shown in FIG. 1A, except that the housing 78 of partial cylinder wall 18 is enlarged so as to accommodate therein not only controller 22 but also input device 23, output device 24, and the circuitry therebetween, including path 26. It will be appreciated that any of the embodiment of FIGS. 2-5 could also be so modified to present such an all-in-one system.

Thus, there has been disclosed a novel bottle label scanning means that allows a label to be scanned, and the resulting image to be downloaded, and printed or otherwise transmitted to a remote device. The imaging chamber allows the scanner to be moved in an arcuate direction about the bottle to scan the label or, alternatively, allows the scanner to be stationary while the bottle and label are rotated on a turntable or rollers in front of the imaging device.

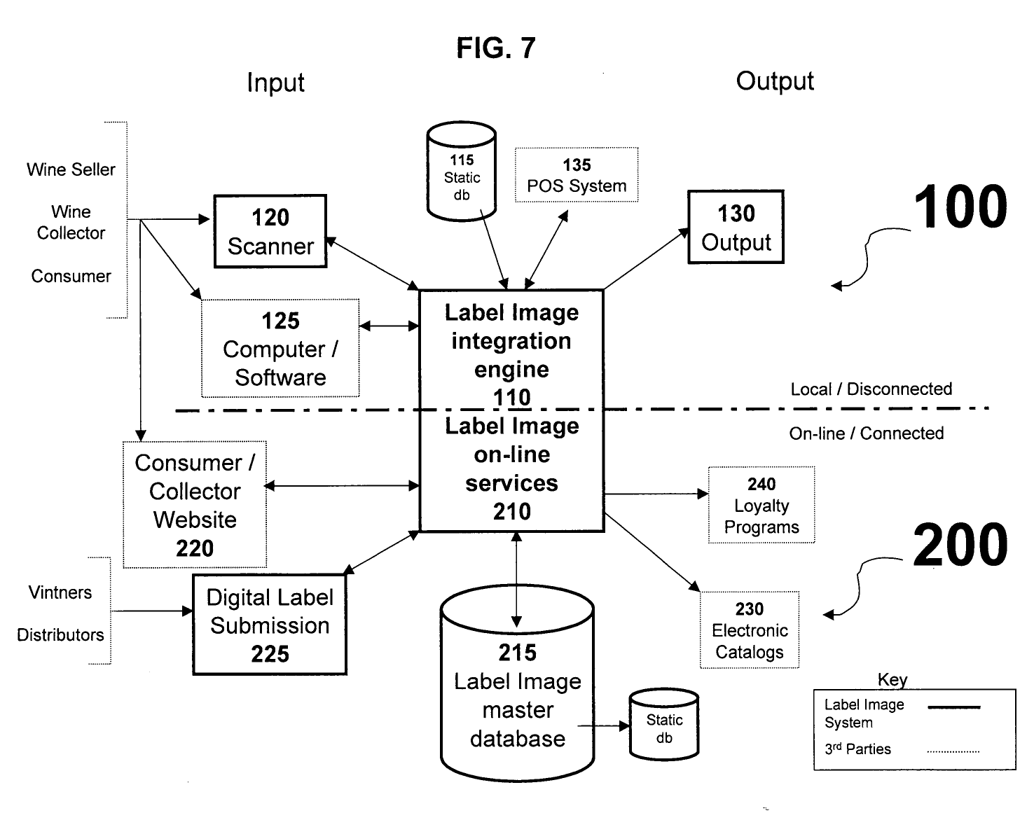

Referring now to FIG. 7, a system of the present invention for storing and retrieving wine bottle label images can be in the form of an off-line system 100 or an on-line system 200. Turning first to off-line system 100, there is a processor 110 that includes a wine label integration engine, comprising appropriate software for carrying out the functions described herein. Processor 110 has the ability to access a static database 115 of wine label images, each image being associated with a code, such as a bar code, or other information by which a desired image can be accessed from the database. The database 115 can be generated by scanning images through a scanner 120 such as one of the embodiments described in detail above in connection with FIGS. 1-6, or some another embodiment. Alternatively, database 115 can be formed of electronic images of wine labels from other sources, such as may be accessed by computer 125, and inputted to database 115 via processor 110. Generally, the off-line system 100 will find greater applicability with users such as restaurants, wine collectors, and consumers. Such users may prefer to generate their own database 115 of wine labels, based on their own private wine collections. The user inputs the code of the wine bottle for which an image is desired. Such input can be in the form of inputting an alphanumeric code such as through computer 125, or by scanning a barcode, or even by use of RFID tag and reader technology, where each bottle is supplied with an RFID tag and the user of the system has an appropriate reader or interrogator of type known to those skilled in the RFID art. Such input also may be used to retrieve other related database information regarding industry and user reviews of specific varieties of wine or recommendations of other wines or products that may complement such varieties. The label image integration engine can further include software that permits a wine collector or wine selling establishment to maintain an inventory of their stock of wines. Thus, when a particular bottle of wine is sold or used, at the time that the database is accessed to generate an image of the label, the database can be updated to reflect the fact that the particular bottle corresponding to the label is no longer in the collection. The database also can be updated to include the date of sale or use of the bottle, and in the case of a sale, the database can include the identity of the purchaser and the price paid for the bottle. For commercial establishments such as restaurants and wine sellers, such information can be used to create purchaser loyalty programs, and to enable such commercial establishments to generate interest in those purchasers in other wines that may be of interest to them.

The illustrated system 100 includes an output device 130. Output device 130 can be in the form of a printer, or it can be in the form of a device that generates an electronic image of a wine label selected from database 115. Such an electronic image can be downloaded as the user may desire, such as into a personal digital assistant, to another electronic device such as a cell phone, to a digital memory device such as a CD, memory card or memory stick, or in the form of an attachment to a message sent to a customer's e-mail address. Processor 110 has software installed therein that allows the selected image to be outputted alone, or with other pertinent information. If the output device 130 is in the form of a printer, such a printed output can be in the form of an embellished souvenir memento of an occasion, in which case the other output information can include the date, the name of the establishment at which the event occurred, and a description of the event, such as a birthday celebration, anniversary celebration, or other special event. The information can be customized as desired. Alternatively, the printed output can be in the form of a sales receipt to enable the customer to remember the purveyor and price of a particular wine. This will advantageously allow the customer to return to that wine seller for a wine that was particularly enjoyed. Such information also can be provided electronically, as described above, depending upon customer preference.

FIG. 7 further illustrates system 200 which operates similarly to system 100 but in which a main website 210 provides on-line services relating to digitized wine label images. The main website 210 can provide access to a master database 215. The images of the database are indexed by code such as a barcode, or other information by which the image can be accessed from the database. The master database 215 can receive digitized wine label images from other websites 220 directed at wine consumers or wine collectors. Similarly, consumers and collectors can use the websites 220 to access the services provided through main website 210. The main website 210 also can include a portal 225 through which vintners and wine distributors can submit digitized images of their wine labels for inclusion in the master database 215. It is expected that such vintners and distributors will choose to subscribe to the services offered through the website 210, as a means of promoting their products. For example, main website 210 can be used to generate electronic catalogs 230 of wines of one or more vintners or distributors. Like system 100, the main database 215 can be indexed via a barcode or some other alphanumeric code which can be inputted into the system. The system can be used to maintain and update inventory listings. It also can be used to generate unique printed or digital outputs for a purchaser or consumer which outputs include an image of the wine bottle label.

It will be understood that some commercial wine labels may contain copyrightable subject matter. The system of the present invention is intended to be used in a manner that respects the copyrights of others. For example, vintners and distributors who supply images of their own wine bottle labels will be granting a license to others to generate copies of such images by the system of the present invention. For vintners and distributors who do not provide digitized images of their wine bottle labels, it is anticipated that permission will be sought from copyright owners before such images are copied in a manner that would otherwise violate a copyright, or that such a system would be used in a manner that would only make copies to the extent allowed by law under fair use principles and the copyright statute. In addition, a “watermark” can be added to the images in the database to prevent unauthorized copying of digitized images by others.

While particular embodiments of the invention have been shown and described in detail, it will be obvious to those skilled in the art that changes and modifications of the present invention, in its various embodiments, may be made without departing from the spirit and scope of the invention. Other elements, steps, methods, and techniques that are insubstantially different from those described herein are also within the scope of the invention. Thus, the scope of the invention should not be limited by the particular embodiments described herein but should be defined by the appended claims and equivalents thereof.

What is claimed is:

1. A method of producing an image of a label, the method comprising
providing access to a database of label images, each image being identified by a code,
providing a device for receiving a label code and generating an image of the label corresponding to the received code, and
inputting a label code into said device, whereby said device accesses said database and generates an image of the corresponding label.

2. The method of claim 1 wherein said code is in the form of a bar code.

3. The method of claim 2 wherein said code is inputted to said device by means of a bar code scanner.

4. The method of claim 1, wherein said code and means for inputting said code use a wireless system.

5. The method of claim 1 wherein said generated image of the label is printed on a print out.

6. The method of claim 5 wherein said printout contains additional data.

7. The method of claim 6 wherein said printout is a receipt of a purchase and said additional data relates to the purchase of a product bearing the label.

8. The method of claim 7 wherein said printout is a record of an occasion at which the product bearing the label was used or consumed, and said additional data relates to the occasion.

9. The method of claim 6 wherein said printout is for archival or inventory purposes and said additional data relates to the acquisition of the product bearing the label.

10. The method of claim 1 wherein said label images are wine bottle label images, and wherein said database is generated by means of an apparatus adapted to generate an image of an arcuate surface, correlate the image to an image code, and store the image with its image code in a database, such that the stored image can be accessed from the database through its corresponding image code.

11. The method of claim 1 wherein said generated image is electronic.

12. The method of claim 5 wherein said electronic generated image is included in an electronic output format that contains additional data.

13. A system for producing an image of a label, the system comprising
a database of label images, each label image in the database having a corresponding code,
a processor for receiving a label code and generating an image of the label corresponding to the received code, and
a means for inputting a label code into said processor, whereby said processor accesses said database and generates an image of the corresponding label.

14. The system of claim 13 said corresponding code is a bar code and said means for inputting said code to said processor comprises a bar code scanner.

15. The system of claim 13 wherein said processor for receiving the label code and generating an image of the corresponding label comprises a microprocessor.

16. The system of claim 13 wherein said microprocessor stores said database.

17. The system of claim 13 wherein said microprocessor allows remote access to the database stored at a remote location.

18. The system of claim 13, further comprising means for correlating additional data with said generated image.

19. The system of claim 13 further comprising means for printing said image.

20. The system of claim 18 further comprising means for printing said image with said additional correlating data.

21. The system of claim 12 wherein said generated image is electronic.

22. A system for storing and retrieving images of wine bottle labels, the system comprising
a database of wine bottle label images,
a computer program for selecting at least one desired wine bottle label image from said database,
means for selectively outputting said selected wine bottle label image in a predetermined format.

23. The system of claim 21 wherein images can be added to said database by means of an apparatus adapted to generate an image of an arcuate surface.

24. The system of claim 21 wherein existing electronic images of wine bottle labels can be added to said database.

25. The system of claim 21 wherein said database is accessible by an internet website.

26. The system of claim 25 wherein electronic wine label images can be added to said database through said internet website.

27. The system of claim 25 wherein images from said database can be downloaded to a user having access to said database.

28. The system of claim 21 wherein said system is adapted for use at a point-of-sale environment, to provide a customer with an image of a wine bottle label at or about the time that the wine is purchased.

29. The system of claim 28 wherein said image is provided to said customer in printed form.

30. The system of claim 28 wherein said image is provided to said customer by electronic mail.

31. The system of claim 21 wherein said output comprises a plurality of wine label images in the format of an electronic catalogue of wine offerings.

32. The system of claim 21 comprising means for keeping a record of a customer's purchases of wines.

33. The system of claim 21, wherein said selected image may be provided with annotations prior to outputting said image from said database.
